(19) United States
(12) Patent Application Publication
(10) Pub. No.: US 2007/0180300 A1
(43) Pub. Date: Aug. 2, 2007

(54) RAID AND RELATED ACCESS METHOD

(75) Inventors: Lana Qin, Beijing (CN); Yong Li, Beijing (CN); Yajun Wu, Beijing (CN)

Correspondence Address: KIRTON AND MCCONKIE, 60 EAST SOUTH TEMPLE,, SUITE 1800, SALT LAKE CITY, UT, 84111, US

(73) Assignee: VIA TECHNOLOGIES, INC., Taipei (TW)

(21) Appl. No.: 11/616,332

(22) Filed: Dec. 27, 2006

(30) Foreign Application Priority Data
Jan. 2, 2006 (TW) 095100105

(51) Int. Cl. G06F 11/00

(52) U.S. Cl. 714/6

(57) ABSTRACT

A RAID includes at least three disks, and the three disks includes respective first blocks corresponding to one another and respective second blocks corresponding to one another. Each of the first and second blocks is divided into a plurality of sub-blocks. One of the first blocks is used as a first parity check block with a check sub-block for storing a check stripe, one of the second blocks is used as a second parity check block with a check sub-block for storing a check stripe, and the other first blocks being used as first data blocks and the other second blocks are used as second data blocks with respective data sub-blocks for storing data stripes, wherein the first parity check block and the second parity check block are disposed in different disks.

### FIELD OF THE INVENTION

The present invention relates in general to redundant array of independent disks (RAID), and more particularly to block arrangement of RAID and related access methods.

### BACKGROUND OF THE INVENTION

Accompanying with the progressive electronic technology, the implement speed of most prime components of a computer system, such as central processing unit (CPU), north bridge, south bridge, memory, and etc., have already exceeded that of the other components of the computer system. For instance, due to the manufacture limit, when reading or writing a disk spends plenty of time on its read-write head's mechanical moving and data disk's rotation, a bottleneck of the running efficiency of a computer system would be rendered. Furthermore, the service life of the disk is limited owing to its frangible mechanical structure and degenerative magnetic material on its surface.

FIG. 1 is a schematic diagram showing a conventional RAID. As show in FIG. 1, the RAID 11, which is electronically connected with a RAID controller 13, includes three disks, and each disk is numbered with a first position number, that is, the disk number. For instance, the disks can be numbered as disk A, disk B and disk C. The memory space in every disk is divided into a plurality of blocks, which are numbered with a second position number, such as block 0 to block 2. Thus, the first position number and the second position number compose a new position number to identify the blocks in RAID 11, such as block A0 to block A2, block B0 to block B2 and block C0 to block C2.

When writing a data into the RAID 11, the RAID controller 13 divides the data into a plurality of data blocks according to the size of a block. Before writing the data blocks into the disk blocks, the RAID controller 13 executes a logic operation to generate corresponding parity data, and writes the parity data into the blocks of the RAID 11 corresponding to the data blocks, respectively. In addition, the blocks for storing the parity data are arranged in the disks in turn, which causes a Rotating Parity Array. For example, the parity data corresponding to the block A0 and block B0 is stored in the block C0, and the parity data corresponding to the block A1 and block C1 are stored in the block B1, while the parity data corresponding to the block B2 and block C2 is stored in the block A2.

As mentioned above, overall performance of the RAID 11 is superior to a general disk. However, some disks in the RAID 11 cannot achieve the furthest efficiency yet for these disks are idle when data being read from the RAID 11. The following case illustrates this circumstance. When the operating system attempts to read the block A0 in the disk A and the block B0 in the disk B, the RAID controller 13 can simultaneously read out the block A0 and block C0, but cannot read out the block B0 simultaneously, so the disk B is idle. This is because the parity data of the block A0 and block B0 is stored in the block C0, and the RAID controller 13 has to read out the parity data in block C0 simultaneously when reading the block A0 in order to check the data block. Similarly, if the RAID controller attempts to read the block B0, it also needs to read out the parity data in the block C0 simultaneously to check the data block. However, it's without question that the disk C cannot be operated to match the disk B since it has being operated to match the disk A. As a result, the disk B is idle when the RAID controller 13 is accessing the disks A and C.

Therefore, for the improvement of the accessing speed and the storage reliability of RAID, it has become an important issue to provide a block arrangement of RAID and related access methods.

### SUMMARY OF THE INVENTION

In view of the foregoing, a RAID and related access methods are provided.

A RAID according to an embodiment of the present invention includes at least three disks, and the three disks includes respective first blocks corresponding to one another and respective second blocks corresponding to one another. Each of the first and second blocks is divided into a plurality of sub-blocks. One of the first blocks is used as a first parity check block with a check sub-block for storing a check stripe, one of the second blocks is used as a second parity check block with a check sub-block for storing a check stripe, and the other first blocks being used as first data blocks and the other second blocks are used as second data blocks with respective data sub-blocks for storing data stripes, wherein the first parity check block and the second parity check block are disposed in different disks.

In an embodiment, the data stripes are accessed according to RAID 0.

The present invention also relates to an access method of a RAID, wherein the RAID includes at least three disks that includes a first parity check block and a plurality of first data blocks corresponding to one another. The method includes receiving a writing instruction and data; dividing the data into a plurality of data stripes including first data stripes to be stored in the first data blocks; generating a first check stripe according to the first data stripes, wherein the number of the first data stripes corresponding to the first check stripe is equal to the number of disks included in the RAID; and independently writing the first check stripe and the first data stripes into a check sub-block of the first parity check block and data sub-blocks of the first data blocks, respectively.

In an embodiment, the method further includes receiving a reading instruction; independently reading data stripes from the first data blocks and a check stripe from the first parity check block according to the reading instruction; checking the read-out data stripes with the read-out check stripe; and packing up and delivering the read-out data stripes passing the check of the read-out check stripe to a message host.

The present invention further relates to an access method of a Rotating Parity RAID, wherein the RAID consists of at least three disks. The method includes dividing the disks into respective blocks corresponding to one another, wherein one of the blocks is used as a parity check block, and other blocks are used as data blocks; dividing each data block into a plurality of data sub-blocks and dividing the parity check block into a plurality of check sub-blocks; dividing an input data into a plurality of data stripes to be stored in data sub-blocks of the data blocks; and generating and storing a check stripe in a check sub-clock of the parity check block according to the data stripes stored in data sub-blocks of the data blocks in different disks.

The various objects and advantages of the present invention will be more readily understood from the following detailed description when read in conjunction with the appended drawing, in which:

### BRIEF DESCRIPTION OF THE DRAWINGS

FIG. 1 is a schematic diagram showing a conventional RAID;

FIG. 2A is a schematic diagram showing the RAID according to an embodiment of the invention;

FIGS. 2B-2D are schematic diagram showing zoom-in blocks illustrated in FIG. 2A;

FIG. 3 is a flow chart showing writing data into the RAID according to a method of the invention;

FIG. 4 is a schematic diagram showing dividing a data into data stripes;

FIG. 5 is a schematic diagram showing operation of a parity data; and

FIG. 6 is a flow chart showing reading data from the RAID according to a method of the invention.

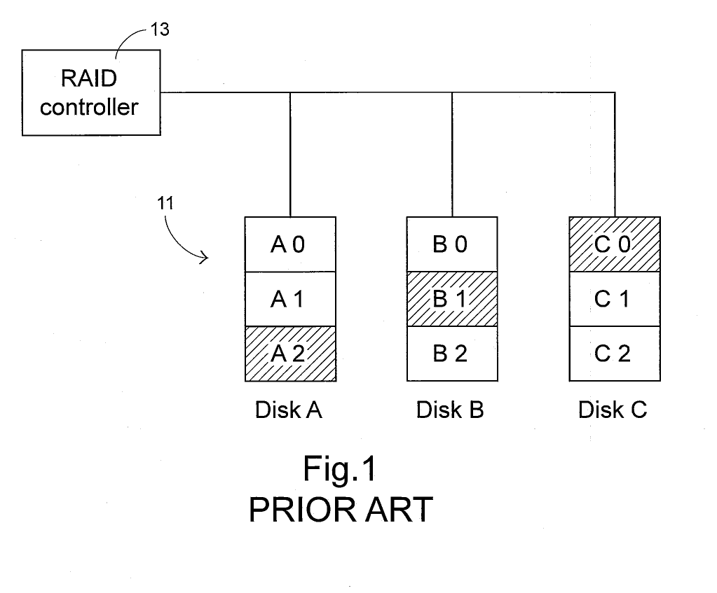

### DETAILED DESCRIPTION

A block arrangement of RAID and a RAID access method according to the embodiments of the invention will be realized from the following detailed description, which proceeds with reference to the accompanying drawings, wherein the same references relate to the same elements.

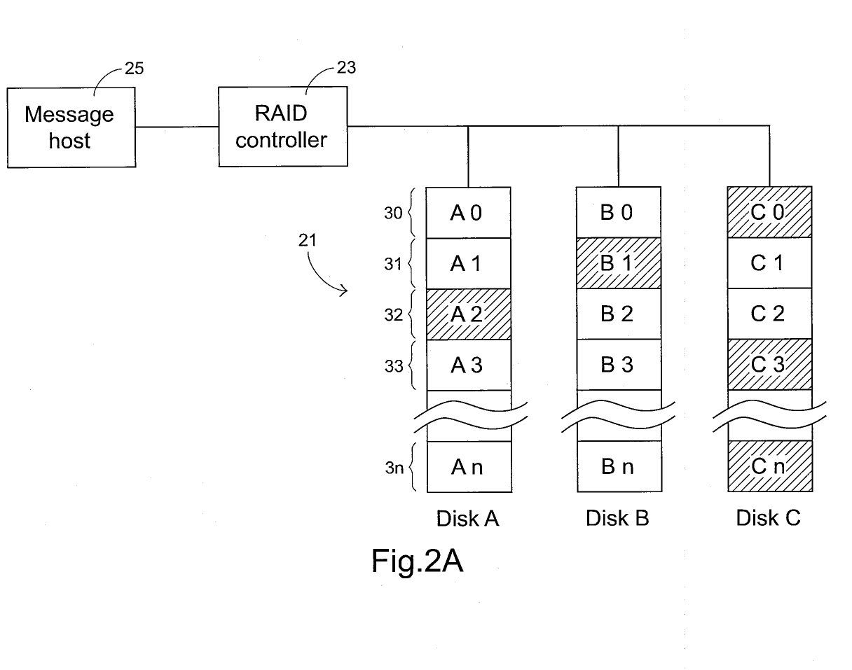

Please refer to FIG. 2A, which is a schematic diagram showing the RAID according to an embodiment of the invention. As shown in FIG. 2A, the RAID 21 according to the present invention includes at least three disks, and is connected with a RAID controller 23 for receiving data from a message host 25. Take the inclusion of three disks in the RAID 21 as an example, wherein each disk is numbered with a disk number, such as disk A, disk B and disk C.

Every disk is divided into n blocks, and each block is numbered with a serial number, such as 0, 1, to n. Thus, the disk number (A, B or C) and the serial number (0 to n) compose a special position number to identify the blocks in each disk. For example, the disk A includes block A0 to block An, the disk B includes block B0 to block Bn and the disk C includes block C0 to block Cn.

For more clear and detailed description, the blocks with the same serial number in the RAID 21, even though in different disks, are identified with the same block row number, such as block row 30 to block row 3n. One of the blocks in each block row is selected as a parity check block to store the parity data corresponding to the data stored in the other blocks of the same block row. The selection of the parity check block is based on the principle of average distribution in the disks (disk A to disk C), and more particularly, the distribution of the parity check blocks composes a rotating parity array. That is to say, for instance, select block C0 as the parity check block of the block row 30, select block B1 as the parity check block of the block row 31, select block A2 as the parity check block of the block row 32, and select block C3 as the parity check block of the block row 33, and so on. Thus, the distribution of the parity check blocks in the disks forms a cycle.

Furthermore, FIGS. 2B-2D are schematic diagrams showing zoom-in blocks illustrated in FIG. 2A. Take the block row 30 as an example, wherein the block C0 is a parity check block 41 to store the parity data, and the other two blocks A0 and B0 are treated as a data storage unit 42 to store data. The blocks, A0 to An, B0 to Bn and C0 to Cn, are divided into a plurality of sub-blocks, respectively, and the sub-blocks in each block are identified with serial numbers 0 to m, respectively. Combined with the position numbers of blocks, the position of each sub-block is identified clearly. Thus, the block A0 includes the sub-blocks A00 to A0m, the block B0 includes the sub-blocks B00 to B0m and the block C0 includes the sub-blocks C00 to C0m.

According to an embodiment of the present invention, the blocks A0 and B0 in the data storage unit 42 are accessed in the way of redundant arrays of independent disk level 0 (RAID 0). As known to those skilled in the art, a RAID 0, which is also known as a stripe set, splits data evenly across two or more disks with no parity information for redundancy. In other words, a RAID 0 is not redundant, and data is shared between drives without redundancy. RAID 0 is normally used to increase performance. An idealized implementation of a RAID 0 is to split I/O operations into equal-sized blocks and spread them evenly across two or more disks. In a RAID 0, each drive is allowed to seek independently when randomly reading or writing data on the disk. If the sectors accessed are spread evenly between two drives then the apparent seek time of the array will be half that of a single non RAID drive (assuming identical disks in the array). The transfer speed of the array will be the transfer speed of all the disks added together, limited only by the speed of the RAID controller. Accordingly, by applying the RAID 0 to the present invention, the sub-blocks A00 to A0m and B00 to B0m store the data stripes of a data, respectively, while the check sub-blocks C00 to C0m correspond to the check stripes derived from the data stripes stored in the sub-blocks A00 to A0m and B00 to B0m. Similar descriptions can be applied to the block row 31, wherein the check sub-blocks B10 to B1m correspond to the check stripes derived from the data stripes stored in the sub-blocks A10 to A1m and C10 to C1m, and applied to the block row 3n, wherein the check sub-blocks Cn0 to Cnm correspond to the check stripes derived from the data stripes stored in the sub-blocks An0 to Acm and Bn0 to Bnm.

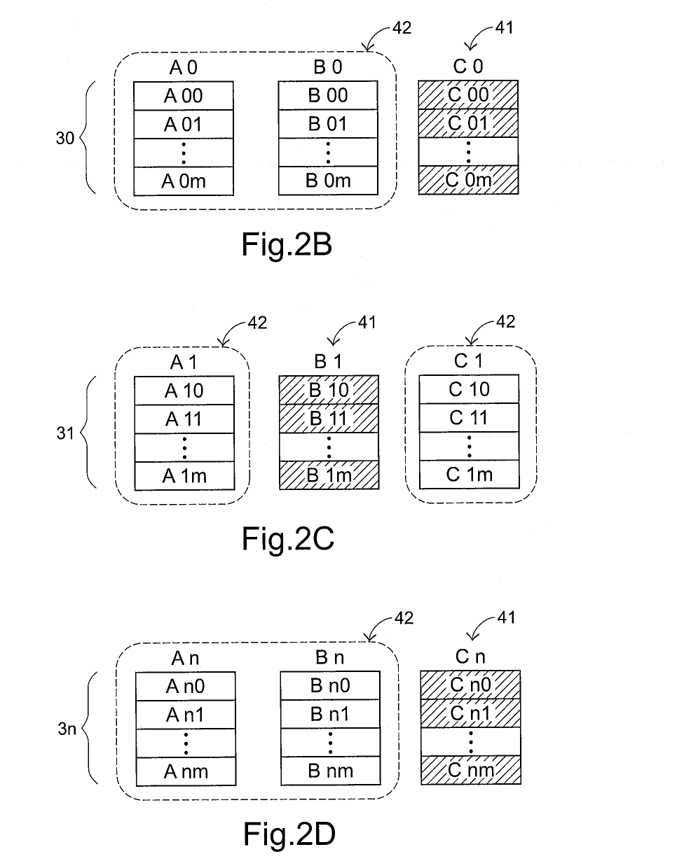

FIG. 3 is a flow chart showing writing data into a RAID according to a method of the invention. As shown in FIG. 3, the writing data procedure includes the following steps. First, in the step 510, the writing instruction and data are received from the message host via the RAID controller; and the data is divided into a plurality of data stripes in the step 520. Then in the step 530, check stripes are generated sequentially according to the data stripes stored in the relevant data storage unit, wherein one check stripe corresponds to a group of data stripes, the number of which is equal to the number of disks in a data storage unit. After that, the groups of the data stripes and the corresponding check stripes are independently written into the relevant sub-blocks and check sub-blocks in the step 540 one group by another.

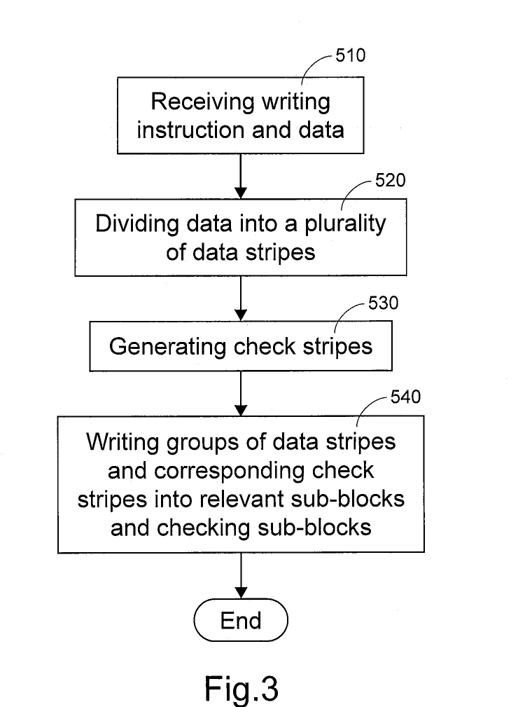

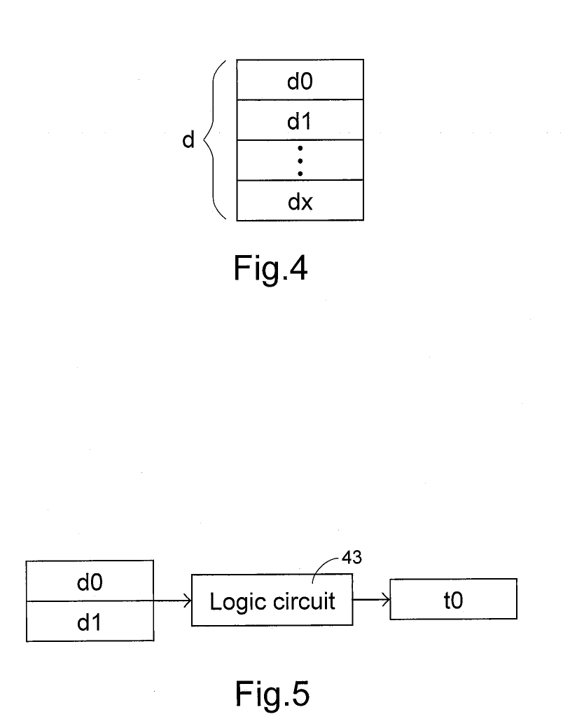

The following description is an example of writing a data d into the RAID according to the procedure of FIG. 3. Please refer to FIG. 4. After receiving the writing instruction and the data d from the message host in the step 510, the data d is divided into a plurality data stripes d0 to dx with the size of a sub-block in the step 520. For the data storage unit 42 including two disks, the step 530 is to operate the two data stripes, for example d0 and d1, through a logic circuit 43 to generate a corresponding check stripe t0 as shown in FIG. 5. Then, according to the step 540, the two data stripes d0, d1 and the check stripe t0 are written into the sub-blocks A00, B00 in the data storage unit 42 and C00 in the parity check block 41 independently. Similarly, repeat the steps 530 to 540 until the data d is completely written into the RAID 21.

In other words, according to the RAID of the present invention, when the message host 25 executes a writing procedure through the RAID controller 23, is the first step is to divide the writing data into a plurality of data stripes with the size of a sub-block, and to write sequentially the data stripes into the data storage units 42 according to the principle of RAID 0. That is, first writing A00, B00, then A01, B01, and then A02, B02, and etc. Meanwhile, operate the two data stripes A00 and B00 through a logic circuit 43 to generate a corresponding check stripe, and write the check stripe into the check sub-block C00. The generation and the writing position of other check stripe are similar to the above.

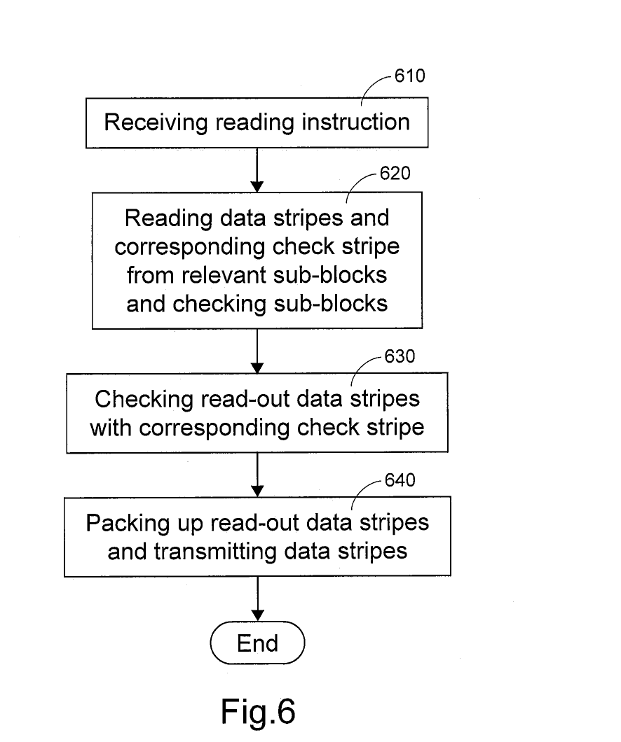

Furthermore, FIG. 6 is a flow chart showing reading data from a RAID according to a method of the invention. The reading data procedure includes the following steps: first, in the step 610 receive a reading instruction from the message host via the RAID controller; then, in the step 620, according to the instruction, read the data stripes and the corresponding check stripes independently from relevant sub-blocks and the check sub-blocks one group by another; check the read out data stripes with the corresponding check stripe in the step 630; and finally, packing up the read out data stripes and transmitting the data stripes to the message host.

The reading procedure described above is based on the principle of RAID 0, and the disks simultaneously read the sub-blocks which store the target data stripes and the corresponding check stripe from the check sub-block. Then the read out data stripes are validated with the corresponding check stripe.

As mentioned above, when the disks in the RAID of the presenting invention are to read or write data, both the data storage unit and the parity check block are simultaneously accessed. Thus, the accessing efficiency of the RAID 21 is improved greatly, and no disk would be destroyed due to overwork since all the disks are simultaneously operated.

In summary, according to the RAID and related access method of the invention, every disk is divided into at least one block, and each block is divided into a plurality of sub-blocks or check sub-blocks, and the data stripes and the corresponding check stripe are independently read from or written to the relevant sub-blocks, so as to improve the accessing efficiency of the RAID greatly.

Although the present invention has been described with reference to specific embodiments thereof, it will be understood that the invention is not limited to the details thereof. Various substitutions and modifications have suggested in the foregoing description, and other will occur to those of ordinary skill in the art. Therefore, all such substitutions and modifications intended to be embraced within the scope of the invention as defined in the appended claims.

What is claimed is:

1. A RAID comprising at least three disks, the three disks comprising respective first blocks corresponding to one another and respective second blocks corresponding to one another, each of the first and second blocks being divided into a plurality of sub-blocks, one of the first blocks being used as a first parity check block with a check sub-block for storing a check stripe, one of the second blocks being used as a second parity check block with a check sub-block for storing a check stripe, and the other first blocks being used as first data blocks and the other second blocks being used as second data blocks with respective data sub-blocks for storing data stripes, wherein the first parity check block and the second parity check block are disposed in different disks.

2. The RAID according to claim 1, wherein the data stripes are accessed according to RAID 0.

3. The RAID according to claim 2, wherein the size of each data stripe is equal to the size of the corresponding data sub-block.

4. The RAID according to claim 1, wherein the RAID is connected to a message host via a RAID controller.

5. An access method of a RAID, the RAID including at least three disks that includes a first parity check block and a plurality of first data blocks corresponding to one another, and the method comprising:
receiving a writing instruction and data;
dividing the data into a plurality of data stripes including first data stripes to be stored in the first data blocks;
generating a first check stripe according to the first data stripes, wherein the number of the first data stripes corresponding to the first check stripe is equal to the number of disks included in the RAID; and
independently writing the first check stripe and the first data stripes into a check sub-block of the first parity check block and data sub-blocks of the first data blocks, respectively.

6. The method according to claim 5, wherein the disks of the RAID further includes a second parity check block, which is disposed in a disk different from the disk where the first parity check block is disposed, and a plurality of second data blocks corresponding to one another, the plurality of data stripes further includes second data stripes to be stored in the second data blocks, and the method further comprises:
generating a second check stripe according to the second data stripes after the first check stripe is generated, wherein the number of the second data stripes corresponding to the second check stripe is equal to the number of disks included in the RAID; and
independently writing the second check stripe and the second data stripes into a check sub-block of the second parity check block and data sub-blocks of the second data blocks, respectively.

7. The method according to claim 5, wherein the size of each of the first data stripes is equal to the size of the corresponding data sub-block.

8. The method according to claim 5, wherein the size of the first check stripe is equal to the size of the corresponding check sub-block.

9. The method according to claim 5, wherein the writing instruction and the data are transmitted from a message host.

10. The method according to claim 5, further comprising:
receiving a reading instruction;
independently reading data stripes from the first data blocks and a check stripe from the first parity check block according to the reading instruction;
checking the read-out data stripes with the read-out check stripe; and
packing up and delivering the read-out data stripes passing the check of the read-out check stripe to a message host.

11. The method according to claim 10, wherein the reading instruction is transmitted from the message host.

12. An access method of a Rotating Parity RAID, wherein the RAID consists of at least three disks, the method comprising:
dividing the disks into respective blocks corresponding to one another, wherein one of the blocks is used as a parity check block, and other blocks are used as data blocks;
dividing each data block into a plurality of data sub-blocks and dividing the parity check block into a plurality of check sub-blocks;
dividing an input data into a plurality of data stripes to be stored in data sub-blocks of the data blocks; and
generating and storing a check stripe in a check sub-clock of the parity check block according to the data stripes stored in data sub-blocks of the data blocks in different disks.

13. The method according to claim 12, wherein the size of each data stripe is equal to the size of the corresponding data sub-block.

14. The method according to claim 12, wherein the size of the check stripe is equal to the size of the corresponding check sub-block.
